(19) United States
(12) Patent Application Publication
(10) Pub. No.: US 2023/0237939 A1
(43) Pub. Date: Jul. 27, 2023

(54) FRAME ASSEMBLY FOR DISPLAYING A TENSIONABLE MEDIA

(71) Applicant: BUDNICK CONVERTING, INC., Columbia, IL (US)

(72) Inventor: Richard J. Hatton, Wellington, OH (US)

(21) Appl. No.: 18/150,560

(22) Filed: Jan. 5, 2023

Related U.S. Application Data
(60) Provisional application No. 63/302,261, filed on Jan. 24, 2022.

(51) Int. Cl. G09F 15/00; G09F 7/18

(52) U.S. Cl. CPC G09F 15/0012; G09F 7/18; G09F 2007/1886; G09F 2007/1843

(57) ABSTRACT

A frame assembly including a first elongated frame section and a second elongated frame section connected by a corner connector. The first elongated frame section has a first mortice channel, and the second elongated frame section has a second mortice channel. The corner connector includes a first tenon that fits with the first mortice channel and a second tenon that fits within the second mortice channel. The first tenon and/or the second tenon may provide a spring bias and may interact with the respective first and/or second mortice slots to apply a spring force that holds the elongated frame sections to the corner connector and thereby connects the elongated frame sections together.

### RELATED APPLICATIONS

This application claims the benefit of U.S. Provisional Application No. 63/302,261 filed Jan. 24, 2022, which is incorporated herein by reference in its entirety.

### TECHNICAL FIELD

The present disclosure generally relates to frame assemblies, and more particularly to a frame assembly for tensionable media.

### BACKGROUND

Silicone edge graphics (SEG) are a class of signage consisting of a frame assembly, typically made of aluminum, which contains slots for receiving a sign face which is printed on textile media. The textile media is attached to the frame by means of silicone edges formed at the margins of the textile media and tucked into the frame slots, providing both attachment and tensioning.

### SUMMARY

The present disclosure relates to a frame assembly comprising a first elongated frame section and a second elongated frame section connected by a corner connector. The first elongated frame section has a first mortice channel, and the second elongated frame section has a second mortice channel. The corner connector comprises a first tenon that fits with the first mortice channel and a second tenon that fits within the second mortice channel. The first tenon and/or the second tenon may provide a spring bias and may interact with the respective first and/or second mortice channels to apply a spring force that holds the elongated frame sections to the corner connector and thereby connects the elongated frame sections together.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

In the annexed drawings, like parts and like features have like designations.

FIG. 1 is a partial schematic illustration of a slotted frame assembly with elongated frame sections aligned at right angles relative to each other and connected using multiple corner connectors.

FIG. 2 is a partial schematic isometric view of a tensionable media inserted into a frame assembly.

FIG. 3 is a schematic isometric view of a tensionable media inserted into a quadrilateral frame assembly.

FIG. 4 is an isometric view of a corner connector being inserted into a first mortice channel of an elongated frame section of the frame assembly.

FIG. 5 is a side view of two elongated frame sections joined together to form a corner of a frame assembly.

FIG. 6 is an isometric view of a corner connector according to a first embodiment.

FIG. 6a is a schematic right-side view of a corner connector according to the first embodiment.

FIG. 6b is a schematic top view of a corner connector according to a first embodiment.

FIG. 6c is a schematic side view of a corner connector according to the first embodiment.

FIG. 7 is a schematic bottom view of a corner connector according to another embodiment.

FIG. 7a is a schematic right side view of a corner connector according to another embodiment.

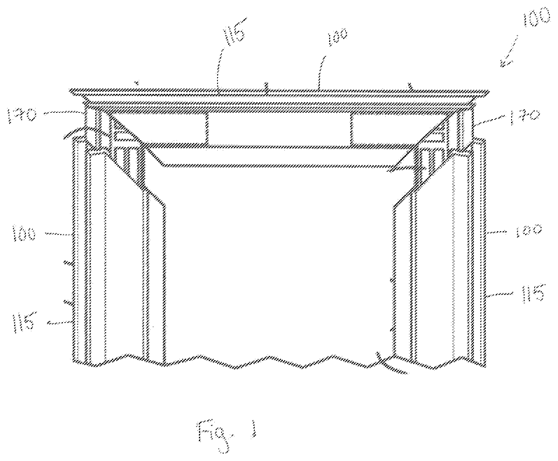

### DETAILED DESCRIPTION

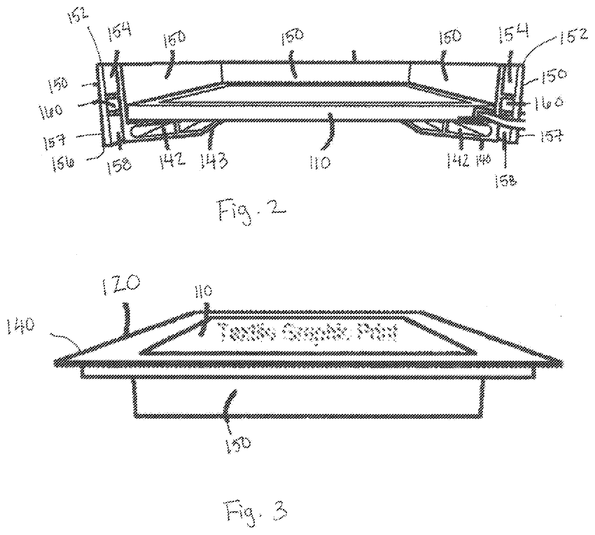

Referring to the drawings, a frame assembly 100 is provided for displaying a tensionable media 110, as shown in FIGS. 2 and 3. The tensionable media 110 may comprise, but is not limited to, a textile media such as a sign. The frame assembly 100 comprises a plurality of side rails 115. In the illustrated embodiment, the frame assembly 100 comprises four side rails 115 connected to form a quadrilateral frame 130. Each side rail 115 comprises one or more elongated frame sections 120. The elongated frame sections 120 are made of, but is not limited to, a polymeric material. The polymeric material may comprise an acrylonitrile butadiene styrene copolymer, polyvinyl chloride, polystyrene, or a mixture of two or more thereof.

Each elongated frame section 120 comprises a base wall 140 and a vertical wall 150 with each extending lengthwise in a longitudinal direction. The base wall 140 comprises a first mortice channel 142 extending through the base wall 140 in the longitudinal direction. The vertical wall 150 extends in a vertical direction from an end 144 of the base wall 140. In a preferred embodiment, the vertical wall 150 extends in a vertical direction from an end 144 of the base wall 140 at a right angle. The vertical wall 150 has an upper end 152 with an upper media mounting slot 154 and an opposite lower end 156 with a lower media mounting slot 158. The upper and lower media mounting slots 154, 158 extend through the vertical wall 150 in the longitudinal direction. The vertical wall 150 includes a second mortice channel 160 which is positioned between the upper media mounting slot 154 and the lower media mounting slot 158 and extends through the vertical wall 150 in the longitudinal direction. Alternatively, the base wall 140 or the vertical wall 150 may comprise both the first mortice channel 142 and the second mortice channel 160. It is to be understood, however, that the base wall 140 and the vertical wall 150 may comprise any number of mortice channels or media mounting slots or no mortice channels or media mounting slots.

In one embodiment, the elongated frame section 120 comprises a unitary construction. Alternatively, the elongated frame section 120 comprises a construction from multiple parts. The elongated frame section 120 may comprise, but is not limited to, a polymeric material. The vertical wall 150 may have a height, as measured from lower end 156 to upper end 152, in the range from, but not limited to, about 25 to about 50 mm, or about 30 to about 45 mm, or about 35 to about 40 mm, or about 38 mm. The elongated frame section 120 may have a width, as measured from end 143 to end 157, in the range from, but not limited to, about 25 to about 50 mm, or from about 30 to about 45 mm, or about 38 mm. The first mortice channel 142, which may be referred to as a large mortice channel, may have a cross-section with heights and widths ranging from, but not limited to, about 3 to about 15 mm, or from about 5 to about 10 mm. The second mortice channel 160, which may be referred to as a small mortice channel, may have a cross-section with heights and widths ranging from, but not limited to, about 3 to about 6 mm, or from about 4 to about 6 mm. The upper medium mounting slot 154 and the lower medium mounting slot 158 may each have a width in the range from, but not limited to, about 3 to about 6 mm, or from about 4 to about 6 mm, and a depth in the range from, but not limited to, about 10 to about 15 mm, or from about 12 to about 15 mm. The length of the elongated frame section 120 may be of any desired value, for example, from about 20 to about 300 cm, or from about 20 to about 120 cm.

The elongated frame section 120 may have a first end 122 and an opposite second end 124, the first and second ends 122 and 124 being cut at acute angles 121 relative to the upper and lower media mounting slots 154 and 158. Alternatively, the elongated frame section 120 may have a first end 122 and an opposite second end 124, the first and second ends 122 and 124 being cut at obtuse angles 123 relative to the upper and lower media mounting slots 154 and 158.

The process for making the elongated frame section 120, may comprise extruding a polymeric material to form the elongated frame section 120. However, it is to be understood that any material or combination of materials can be used to form the elongated frame section 120. The polymeric material may comprise an acrylonitrile butadiene styrene (ABS) copolymer, polyvinyl chloride, polystyrene, or a mixture of two or more thereof.

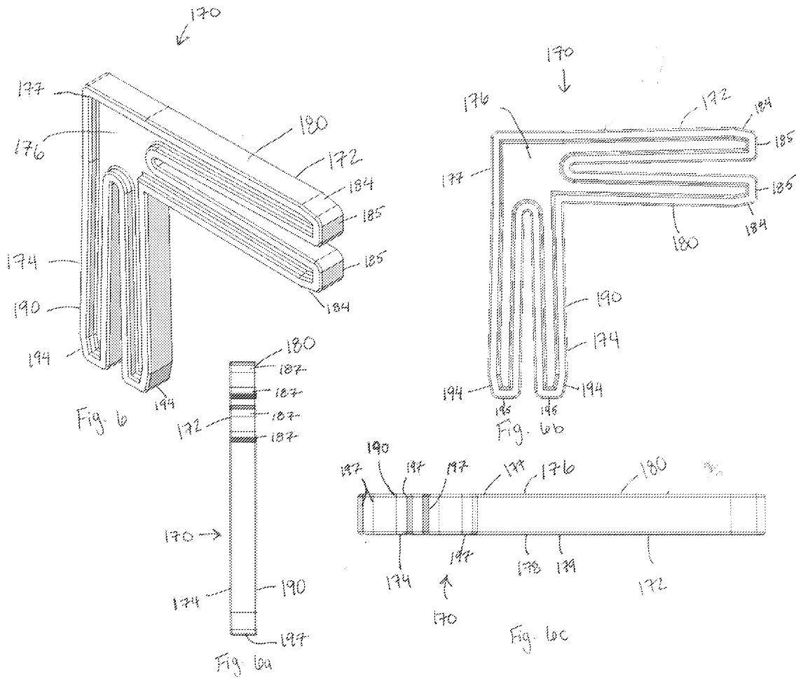

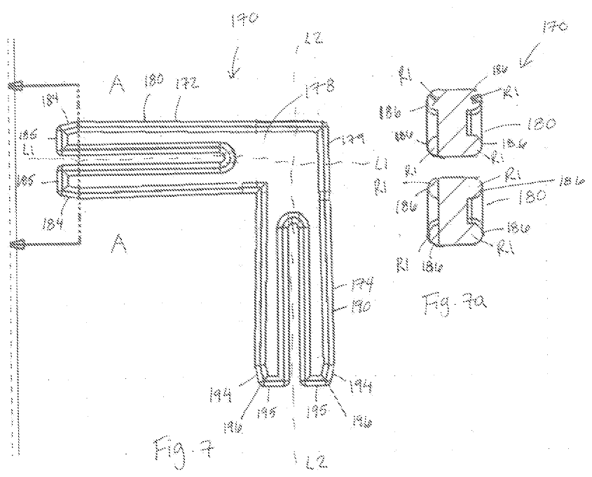

Referring to FIGS. 6-7, the frame member may further comprise a corner connector 170. The corner connector 170 may comprise a top surface 176 and a bottom surface 178. The top surface 176 may comprise a raised edge 177 disposed along the entire perimeter of the top surface 176. Alternatively, the raised edge 177 may be disposed along a portion of the perimeter of the top surface 176. Similarly, the bottom surface 178 may comprise a raised edge 179 disposed along the entire perimeter of the bottom surface 178 or a portion of the perimeter of the bottom surface 178. Both the raised edge 177 and the raised edge 179 may be rounded so that each raised edge 177, 179 comprises a radius rather than an angular profile. Thus, by making the raised edges 177, 179 rounded, the raised surfaces of the corner connector 170 comprise radii and thus have radial profiles rather than angular profiles.

The corner connector 170 is configured to be inserted into the first mortice channel 142, the second mortice channel 160, and/or the side mortice channel 146 of an elongated frame section 120. When the corner connector 170 is inserted, the edges 177, 179 are adjacent to side walls of the first mortice channel 142, the second mortice channel 160, and/or the side mortice channel 146. With the edges 177, 179 being rounded, the corner connector 170 can accommodate a larger number of variances between the corner connector 170 and the any mortice channel of an elongated frame section 120. Also, the radial profile of the edges 177, 179 allows the corner connector 170 to be inserted into any mortice channel of the elongated frame 120 in a smooth manner to provide a snug fit without any jamming or binding when the corner connector 170 is inserted or removed from any mortice channel of an elongated frame section 120. Furthermore, the radii of the raised edges 177, 179 permits the corner connector 170 to be created in a more efficient and cost-effective injection molding process than connectors having raised surfaces with an angular profile, as the injection molding die for the corner connector 170 can be produced by a Computer Numerical Control (CNC) router with only a single radius bit.

The corner connector 170 may comprise a first tenon 172 extending in a first direction and a second tenon 174 extending in a second direction. The first direction may be disposed at any angle from the second direction. In one embodiment, the first tenon 172 is perpendicular to the second tenon 174. The first tenon 172 may comprise a plurality of fingers 180. The second tenon 174 may comprise a plurality of fingers 190. In the illustrated embodiment, the first tenon 172 comprises two fingers, and the second tenon 174 comprises two fingers.

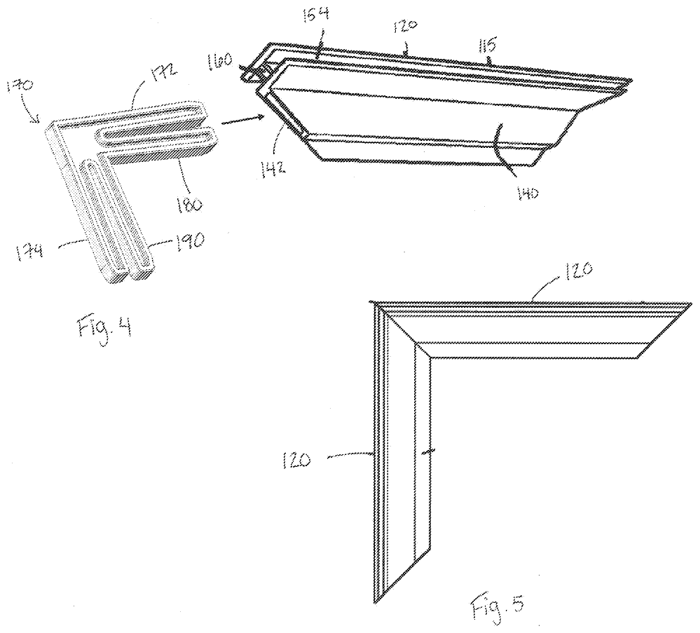

The first tenon 172 may be configured so that the plurality of fingers 180 fits within the first mortice channel 142 of a first elongated frame section 120, as shown in FIG. 4. The second tenon 174 may be configured so that the plurality of fingers 190 may fit within the first mortice channel 142 of a second elongated frame section. It to be understood, however, that the plurality of fingers 180 and/or the plurality of fingers 190 may be configured to fit in any mortice channel on an elongated frame section 120, such as, but not limited to, the second mortice channel 160.

The plurality of fingers 180 may comprise a spring bias. In one embodiment, the plurality of fingers 180 may comprise an outward spring bias. The first tenon 172 is fitted within the first mortice channel 142 of a first elongated frame section 120. The outward spring bias of the plurality of fingers 190 causes the plurality of fingers 190 to expand away from one another and apply an outward spring force onto the inner walls of the first mortice channel 142. The spring force of the plurality of fingers 180 is sufficient to hold the corner connector 170 within the first mortice channel 142 by friction alone. Additionally, the first mortice channel 142 may be configured to compress the plurality of fingers 180 to ensure a tight fit between the plurality of fingers 180 and the inner walls of the first mortice channel 142, as the resiliency of the plurality of fingers 180 moves the plurality of fingers 180 outwards towards the inner walls of the first mortice channel 142 of the first elongated frame section 120.

The plurality of fingers 190 may also comprise a spring bias. The plurality of fingers 190 may comprise an outward spring bias. The second tenon 174 is fitted within the first mortice channel 142 of a second elongated frame section 120. The outward spring bias of the plurality of fingers 190 causes the plurality of fingers 190 to expand away from one another and apply an outward spring force onto the inner walls of the first mortice channel 142. The spring force of the plurality of fingers 190 is sufficient to hold the corner connector 170 within the first mortice channel 142 by friction alone. Additionally, the first mortice channel 142 may be configured to compress the plurality of fingers 190 to ensure a tight fit between the plurality of fingers 190 and the first mortice channel 142, as the resiliency of the plurality of fingers 190 moves the plurality of fingers 190 outwards towards the inner walls of the first mortice channel 142 of the second elongated frame section 120.

Alternatively, the plurality of fingers 180 comprises an inward spring bias. Some of the plurality of fingers 180 are fitted within the first mortice channel 142 and some of the plurality of fingers 180 are fitted within the second mortice channel 160 of a first elongated frame section 120. The inward spring bias of the plurality of fingers 190 causes the plurality of fingers 190 to compress towards one another and apply an inward spring force onto the inner walls of the first mortice channel 142 and the second mortice channel 160. The spring force of the plurality of fingers 180 is sufficient to hold the corner connector 170 within the first mortice channel 142 and the second mortice channel 160 by friction alone. Additionally, the first mortice channel 142 and/or the second mortice channel 160 may be configured to expand the plurality of fingers 180 to ensure a tight fit between the plurality of fingers 190 and the first and second mortice channels 142, 160 of the first elongated frame section 120, as the resiliency of the plurality of fingers 180 moves the plurality of fingers 180 inwards towards the inner walls of the first and second mortice channels 142, 160 of the first elongated frame section 120.

The plurality of fingers 190 may comprises an inward spring bias. Some of the plurality of fingers 190 are fitted within the first mortice channel 142 and some of the plurality of fingers 190 are fitted within the second mortice channel 160 of a second elongated frame section 120. The inward spring bias of the plurality of fingers 190 causes the plurality of fingers 190 to compress towards one another and apply an inward spring force onto the inner walls of the first mortice channel 142 and the second mortice channel 160. The spring force of the plurality of fingers 190 is sufficient to hold the corner connector 170 within the first mortice channel 142 and the second mortice channel 160 by friction alone. Additionally, the first mortice channel 142 and/or the second mortice channel 160 may be configured to expand the plurality of fingers 190 to ensure a tight fit between the plurality of fingers 190 and the first and second mortice channels 142, 160 of the second elongated frame section 120, as the resiliency of the plurality of fingers 190 moves the plurality of fingers 190 inwards towards the inner walls of the first and second mortice channels 142, 160 of the second elongated frame section 120.

It is to be noted that in embodiments in which there are more than two fingers 180 and/or 190, the fingers 180 and/or 190 may comprise any combinations of a portion of the fingers 180 and/or 190 comprising a spring bias in an outward direction, a portion of fingers 180 and/or 190 comprising a spring bias in an inward direction, and a portion of fingers 180 and/or 190 comprising no spring bias.

Furthermore, the plurality of fingers 180 may be parallel to a longitudinal line L1 of the first tenon 172. In another embodiment, the plurality of fingers 180 diverge way from the longitudinal line L1 and away from one another. In yet another embodiment, the plurality of fingers 180 may diverge towards the longitudinal line L1 and diverge towards one another. In still another embodiment, the plurality of fingers 180 may comprise any combination of a portion of the plurality of fingers 180 diverging away from the longitudinal line L1, a portion of the plurality of fingers 180 diverging toward the longitudinal line L1, and a portion of the plurality of fingers 180 that are parallel to the longitudinal line L1.

The plurality of fingers 190 may be parallel to a longitudinal line L2 of the second tenon 174. In another embodiment, the plurality of fingers 190 diverge way from the longitudinal line L2 and away from one another. In yet another embodiment, the plurality of fingers 190 may diverge towards the longitudinal line L2 and diverge towards one another. In still another embodiment, the plurality of fingers 190 may comprise any combination of a portion of the plurality of fingers 190 diverging away from the longitudinal line L2, a portion of the plurality of fingers 190 diverging toward the longitudinal line L2, and a portion of the plurality of fingers 190 that are parallel to the longitudinal line L2.

In the illustrated embodiment, the plurality of fingers 180 comprise a rectangular shape. An outward side 183 of the plurality of fingers 180 may include a beveled portion 184 near an end surface 185 of the plurality of fingers 180. In one embodiment, the end surface 185 of the plurality of fingers 180 generally has a rectangular shape, as shown in FIG. 6c. The edges 187 of the plurality of fingers 180 may be rounded, and the first tenon 172 can be easily inserted into any mortice channel of an elongated frame section 120 without binding or slippage. The edges 187 are configured to engage with the first mortice channel 142 of the first elongated section 120 to hold the first elongated frame section 120 to the corner connector 170.

In another embodiment, the end surface 185 of the plurality of fingers 180 generally has an I-shape, as shown in FIG. 7a. The corners 186 of the end surface 185 may be rounded so that each corner connector can comprise a radius and have a radial profile rather than an angular profile. The radii R1 of the corners 186 of the end surface 185 may all be equal. When the radii R1 are equal, the first tenon 172 of the corner connector 170 can be inserted into any mortice channel of an elongated frame section 120 with a snug fit without binding or jamming when the corner connector 170 is inserted or removed from any mortice channel of an elongated frame section 120. This allows for the corner connector 170 to accommodate a larger number of variances between the plurality of fingers 180 and any mortice channel of a first elongated frame section 120. Furthermore, when the radii R1 are all equal, the injection molding process is more efficient in time and cost, as the injection molding die can be produced by a CNC router with a single radius bit, as opposed to an angular profile of the corners 186. Once the plurality of fingers 180 are inserted into any mortice channel of a first elongated frame section 120, the spring bias of the plurality of fingers 180 secures the first tenon 172 in a mortice channel of an elongated frame section 120 without slippage.

Similarly, the plurality of fingers 190 comprise a rectangular shape. An outward side 193 of the plurality of fingers 190 may include a beveled portion 194 near an end surface 195 of the plurality of fingers 190. In one embodiment, the end surface 195 of the plurality of fingers 190 generally has a rectangular shape. The edges 197 of the plurality of fingers 190 may be rounded, and the second tenon 174 can be easily inserted into any mortice channel of an elongated frame section 120 without binding or slippage. The edges 197 are configured to engage with the first mortice channel 142 of the second elongated section 120 to hold the second elongated frame section 120 to the corner connector 170.

In another embodiment, the end surface 195 of the plurality of fingers 10 generally has an I-shape. The corners 196 of the end surface 195 may be rounded so that each corner connector can comprise a radius and have a radial profile rather than an angular profile. The radii R2 of the corners 196 of the end surface 195 may all be equal. When the radii R2 are equal, the second tenon 174 of the corner connector 170 can be inserted into any mortice channel of an elongated frame section 120 with a snug fit without binding or jamming when the corner connector 170 is inserted or removed from any mortice channel of an elongated frame section 120. This allows for the corner connector 170 to accommodate a larger number of variances between the plurality of fingers 190 and any mortice channel of a second elongated frame section 120. Furthermore, when the radii R2 are all equal, the injection molding process is more efficient in time and cost, as the injection molding die can be produced by a CNC router with a single radius bit, as opposed to an angular profile of the corners 196. The single radius bit may also be the same bit for the radii R1 of the corners 186 of the first tenon 172. Once the plurality of fingers 190 are inserted into any mortice channel of a second elongated frame section 120, the spring bias of the plurality of fingers 190 secures the second tenon 174 in a mortice channel of an elongated frame section 120 without slippage.

In a preferred embodiment, the size of radii R1 of the corners 186 of the first tenon 172 and the size of radii R2 of the corners 196 of the second tenon 174 are equal. However, it is to be understood that radii R1 and radii R2 can be different sizes. When the sizes of radii R1 and radii R2 are equal, both the first tenon 172 and the second tenon 174 of the corner connector 170 fit easily in the mortice channels of multiple elongated frame sections 120 without binding. The spring bias of the plurality of fingers 180 and the spring bias of the plurality of fingers 190 secure the first tenon 172 and the second tenon 174 in the mortice channels of multiple elongated frame sections 120 without slippage by applying spring forces that hold the elongated frame sections 120 to the corner connector 170 and thereby connects the elongated frame section 120 together. Accordingly, the corner connector 170 secures the multiple elongated frame sections together.

The corner connector 170 may comprise a uniform construction. Alternatively, the corner connector 170 may comprise multiple parts. Furthermore, the corner connector 170 may comprise one or more materials and may be constructed from any material. In one embodiment, the corner connector 170 may comprise a polymeric material. The polymeric material may comprise, but is not limited to, an acrylonitrile butadiene styrene copolymer, polyvinyl chloride, polystyrene, or a mixture of the two or more thereof. In one embodiment, the first tenon 172 and the second tenon 174 are made from the same material. Alternatively, the first tenon 172 may comprise at least one different material than the second tenon 174. Furthermore, the first tenon 172 and/or the second tenon 174 are constructed with a first material and reinforced with a second material.

The corner connector 170 may be made by a process comprising molding the polymeric material to form the corner connector. However, it is to be understood that any material can be used to form the corner connector 170. The polymeric material may comprise, but is not limited to, an acrylonitrile butadiene styrene (ABS) copolymer, polyvinyl chloride, polystyrene, or a mixture of two or more thereof.

Referring to FIG. 5, the frame assembly 100 may comprise a first elongated frame section 120 aligned orthogonally with and connected to a second elongated frame section 120 to form a corner 250 of the quadrilateral frame 130 using the corner connector 170.

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “X and/or Y,” when used in conjunction with open-ended language such as “comprising” can refer, in one embodiment, to X without Y (optionally including elements other than Y); in another embodiment, to Y without X (optionally including elements other than X); in yet another embodiment, to both X and Y (optionally including other elements); etc.

The word “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” may refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phrase “at least one,” in reference to a list of one or more elements, should be understood to mean at least one element selected from any one or more of the elements in the list of elements, but not necessarily including at least one of each and every element specifically listed within the list of elements and not excluding any combination of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of X and Y” (or, equivalently, “at least one of X or Y,” or, equivalently “at least one of X and/or Y”) can refer, in one embodiment, to at least one, optionally including more than one, X, with no Y present (and optionally including elements other than Y); in another embodiment, to at least one, optionally including more than one, Y, with no X present (and optionally including elements other than X); in yet another embodiment, to at least one, optionally including more than one, X, and at least one, optionally including more than one, Y (and optionally including other elements); etc.

The transitional words or phrases, such as “comprising,” “including,” “carrying,” “having,” “containing,” “involving,” “holding,” and the like, are to be understood to be open-ended, i.e., to mean including but not limited to.

While the invention has been explained in relation to various embodiments, it is to be understood that various modifications thereof will become apparent to those skilled in the art upon reading the specification. Therefore, it is to be understood that the invention disclosed herein includes any such modifications that may fall within the scope of the appended claims.

1. A frame assembly, comprising:
a first elongated frame section having a first mortice channel,
a second elongated frame section having a second mortice channel, and
a corner connector having a first tenon that fits within the first mortice channel and a second tenon that fits within the second mortice channel,
wherein the first tenon and/or the second tenon provide a spring bias and interact with the respective first and/or second mortice channels to apply a spring force that holds the elongated frame sections to the corner connector and thereby connects the elongated frame sections together.

2. The frame assembly of claim 1, wherein the first tenon and/or the second tenon provide an outward spring bias.

3. The frame assembly of claim 2, wherein the first and/or second mortice channels compress the respective first and/or second tenons.

4. The frame assembly of claim 1, wherein the first tenon and/or the second tenon provide an inward spring bias.

5. The frame assembly of claim 4, wherein the first and/or second mortice channels expand toward the respective first and/or second tenons.

6. The frame assembly of claim 1, wherein the spring force of the first tenon and/or the second tenon is configured to hold the elongated frame sections to the corner connector by friction.

7. The frame assembly of claim 1, wherein the first tenon has a plurality of fingers, and the second tenon has a plurality of fingers.

8. The frame assembly of claim 7, wherein the plurality of fingers of the first tenon diverge inwardly or outwardly relative to each other, and
wherein the plurality of fingers of the second tenon diverge inwardly or outwardly relative to each other.

9. The frame assembly of claim 7, wherein the plurality of fingers of the first tenon comprises end faces having rounded edges that engage the first mortice channel to hold the first elongated frame section to the corner connector, and
wherein the plurality of fingers of the second tenon comprises end faces having rounded edges that engage with the second mortice channel to hold the second elongated frame section to the corner connector.

10. The frame assembly of claim 9, wherein the rounded edges of the first tenon are configured to permit ease of insertion of the first tenon into the first mortice channel, and
wherein the rounded edges of the second tenon are configured to permit ease of insertion of the second tenon into the second mortice channel.

11. The frame assembly of claim 7, wherein an outward surface of the plurality of fingers of the first tenon comprises a beveled portion, and
wherein an outward surface of the plurality of fingers of the second tenon comprises a beveled portion.

12. The frame assembly of claim 7, wherein the plurality of fingers of the first tenon comprises an end surface having rounded corners with a first set of radii.

13. The frame assembly of claim 12, wherein the plurality of fingers of the second tenon comprises an end surface having rounded corners with a second set of radii.

14. The frame assembly of claim 13, wherein the size of the first set of radii is equal to the size of the second set of radii.

15. The frame assembly of claim 1, wherein the corner connector further comprises:
a top surface having a first raised edge disposed around the entire perimeter of the top surface; and
a bottom surface having a second raised edge disposed around the entire perimeter of the bottom surface.

16. The frame assembly of claim 15, wherein the first raised edge is rounded and the second raised edge is rounded.

17. The frame assembly of claim 1, wherein the first tenon extends in a first direction and the second tenon extends in a second direction.

18. The frame assembly of claim 17, wherein the first direction is perpendicular to the second direction.

19. The frame assembly of claim 1, wherein the corner connector comprises a uniform construction.

20. The frame assembly of claim 1, wherein the corner connector comprises a polymeric material.
